(19) United States
(12) Patent Application Publication
(10) Pub. No.: US 2016/0037233 A1
(43) Pub. Date: Feb. 4, 2016

(54) INFORMATION PROVISION SYSTEM AND METHOD OF PROVIDING INFORMATION

(71) Applicant: PANASONIC INTELLECTUAL MANAGEMENT CO., LTD., OSAKA (JP)

(72) Inventors: Kouichi MATSUMURA, Osaka (JP); Sako KONDO, Osaka (JP); Masafumi SHIMOTASHIRO, Osaka (JP); Rumi OHNISHI, Osaka (JP)

(21) Appl. No.: 14/753,044

(22) Filed: Jun. 29, 2015

(30) Foreign Application Priority Data
Aug. 1, 2014 (JP) 2014-157901

(51) Int. Cl. H04N 21/81; H04N 21/231; H04N 21/262; H04N 21/414; H04N 21/435; H04N 21/43; H04N 21/254; H04N 21/41

(52) U.S. Cl. CPC H04N 21/8133; H04N 21/254; H04N 21/23106; H04N 21/4126; H04N 21/41407; H04N 21/435; H04N 21/4307; H04N 21/26283; H04N 21/812; H04N 21/2625

(57) ABSTRACT

An information provision system provides a program-related information in parallel with broadcast of a television program. The system includes: a program-related information server; a television receiver; and a terminal apparatus. The terminal apparatus includes: a display unit; a program-related information display controller for acquiring the program-related information, and for displaying the acquired program-related information in a first display region on the display unit; and a net information display controller for acquiring net information from a net information server, and for displaying the acquired net information in a second display region on the display unit. The net information display controller displays the net information in the second display region after a lapse of a predetermined delay time.

### BACKGROUND

1. Field

The present disclosure relates to information provision systems for providing program-related information, which is supplementary information linked to contents of television programs, in parallel with broadcasts of the television programs. In particular, the present disclosure relates to an information provision system for displaying net information, which can be acquired via a communication network such as the Internet, as well as the program-related information on a terminal apparatus.

2. Description of the Related Art

An information provision system has been proposed which provides program-related information, which is supplementary information linked to contents of a television program, in parallel with the broadcast of the television program. According to the information provision system, during viewing the television program on a television receiver, the program-related information, i.e. the supplementary information linked to contents of the television program currently received with the television receiver, is displayed on a terminal apparatus such as a smartphone in wireless connection with the television receiver. The program-related information is, for example, advertising information relevant to the television program currently received with the television receiver, or detailed information of the program (such as information on an introduction of characters).

In the information provision system, a program-related information ID to identify the program-related information is transmitted, together with the television program, via a broadcast wave at a timing intended by a broadcast station. Upon receiving the program-related information ID, the television receiver transfers the program-related information ID to a terminal apparatus via wireless communication. On the other hand, the terminal apparatus executes a specific application program (As used herein, the term “APP” is an abbreviation for an application program). Upon every reception of the program-related information ID, the terminal apparatus acquires program-related information corresponding to the program-related information ID via the Internet, and displays it on a screen of the terminal apparatus. Such APP allows a user watching the television program to view the program-related information (advertisement information, or information on an introduction of the characters and the like) linked to contents of the television program currently-viewed on the television receiver, by using the terminal apparatus on hand. With this configuration, the program-related information can be displayed on the user's terminal apparatus at a timing intended by the broadcast station, which results in an enhancement in convenience for the user viewing the television program. In addition to this, when advertising is made as program-related information, the information of contents of the broadcast being currently viewed on the television receiver can also be confirmed by using the terminal apparatus simultaneously with the broadcast, which allows an enhanced effect in advertising.

By the way, in recent years, an information delivery technology has been proposed for advertisements (net advertisements) on a communication network most notably the Internet (see Japanese Patent No. 4980371, for example). In this technology, such APP described above allows not only the display of the program-related information, but also a simultaneous display of information (referred to as “net information,” hereinafter), most notably net advertisements, which is provided on the communication network such as the Internet. In order for the broadcast station to obtain revenue from delivery of the net information without reducing the effectiveness of advertising provided by the program-related information, the broadcast station desires that a user views, with great concentration, the television programs displayed on the television receiver, the program-related information displayed on the terminal apparatus, and the net information displayed on the terminal apparatus, in this order.

### SUMMARY

An information provision system according to the present disclosure is intended to provide program-related information in parallel with broadcast of a television program, with the program-related information being supplementary information linked to contents of the television program. The information provision system includes a program-related information server, a television receiver, and a terminal apparatus. The program-related information server holds the program-related information of the television program to be possibly broadcast, and provides the program-related information via a communication network, following an instruction from the outside. The television receiver receives, via a broadcast wave, the television program and a program-related information ID to identify the program-related information of the television program. The terminal apparatus receives, from the television receiver, the program-related information ID received by the television receiver. The terminal apparatus includes a display unit, a program-related information display controller, and a net information display controller. The display unit includes a display screen. Upon receiving the program-related information ID, the program-related information display controller transmits the program-related information ID to the program-related information server, thereby acquiring the program-related information corresponding to the program-related information ID from the program-related information server. Then, the program-related information display controller displays the acquired program-related information in a first display region on the display unit. The net information display controller acquires net information via the communication network from a net information server connected to the communication network, with the net information being held by the net information server. Then, the net information display controller displays the acquired net information in a second display region on the display unit. The program-related information display controller displays the net information in the second display region after a lapse of a predetermined delay time since the program-related information is displayed in the first display region.

### BRIEF DESCRIPTION OF DRAWINGS

FIG. 1 is a view of a configuration of an information provision system according to an embodiment;

FIG. 2 is a block diagram illustrating a configuration of a television receiver shown in FIG. 1;

FIG. 3 is a block diagram illustrating a configuration of a terminal apparatus shown in FIG. 1;

FIG. 4 is a block diagram illustrating a configuration of a program-related information server shown in FIG. 1;

FIG. 5 is a view of an example of a program-related information table which is held in the program-related information server;

FIG. 6 is a communication sequence illustrating an operation of the information provision system according to the embodiment;

FIG. 7 is a view of an example of display of program-related information and net information on the terminal apparatus;

FIG. 8 is a flowchart illustrating a method of forming delay information in the program-related information table that is held by the program-related information server according to the embodiment;

FIG. 9 is a flowchart of a procedure by which the program-related information server transmits the delay information to the terminal apparatus, according to the embodiment;

FIG. 10 is a communication sequence illustrating an operation of an information provision system according to a modified example of the embodiment;

FIG. 11 is a view of another example of the program-related information table which is held in the program-related information server; and

FIG. 12 is a view of another example of the display of the program-related information and the net information on the terminal apparatus.

### DETAILED DESCRIPTION

Hereinafter, descriptions will be made regarding an information provision system and a method of providing information according to embodiments of the present disclosure, with reference to the accompanying drawings. However, descriptions in more detail than necessary will sometimes be omitted. For example, detailed descriptions of well-known items and duplicate descriptions of substantially the same configuration will sometimes be omitted, for the sake of brevity and easy understanding by those skilled in the art.

Moreover, it is noted that the present inventors provide the accompanying drawings and the following descriptions so as to facilitate fully understanding of the present disclosure by those skilled in the art; therefore, the accompanying drawings and the following descriptions are in no way intended to impose any limitation on the subject matter described in the appended claims. That is, the embodiments to be described hereinafter are each a preferred embodiment according to the present invention. Values, constituent elements, arrangement positions and connection configurations of the constituent elements, steps, order of the steps, and the like to be described in the following embodiments are nothing more than examples, and are in no way intended to impose any limitation on the present invention. Moreover, of the constituent elements in the following embodiments, the constituent elements not described in the independent claims which each show the most generic concept of the present invention, will be described as optional constituent elements to configure more preferred embodiments.

### Exemplary Embodiments

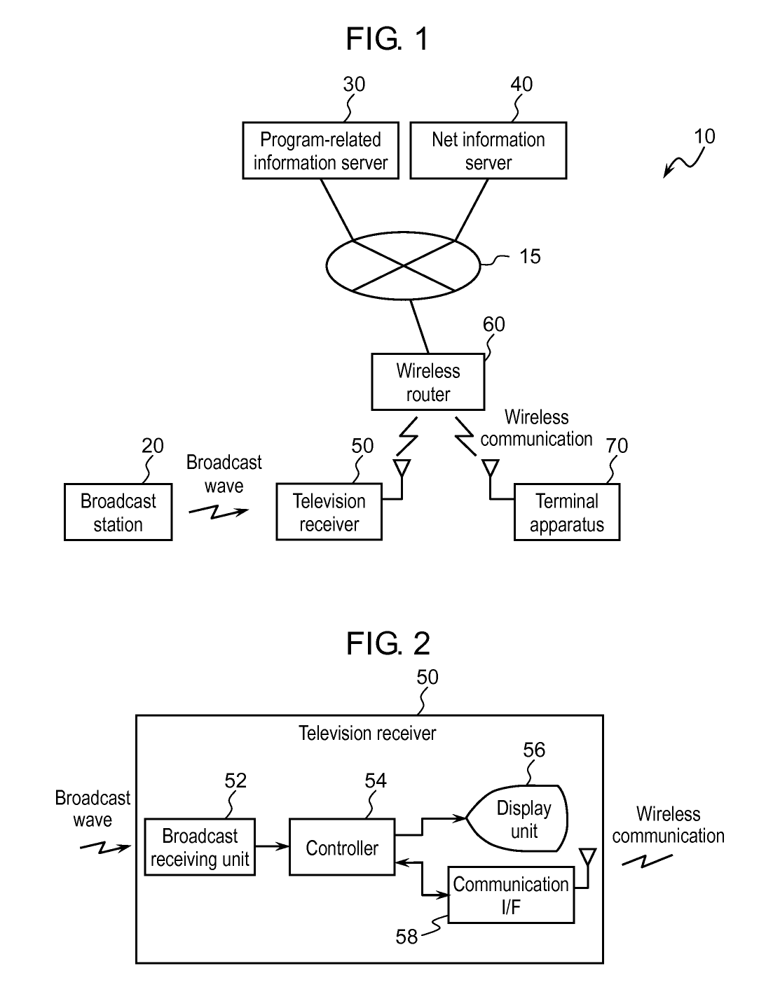

Hereinafter, an embodiment will be described with reference to FIGS. 1 to 9.

### [1. Configuration]

### [1-1. Configuration of Network Connection]

FIG. 1 is a view of a configuration of information provision system 10 according to the embodiment.

Information provision system 10 is a system to provide program-related information, which is supplementary information linked to contents of a television program, in parallel with broadcast of the television program. The information provision system includes program-related information server 30, television receiver 50, and terminal apparatus 70. Note that, the followings are also shown in the figure as constituent elements involved in information provision system 10, that is, broadcast station 20, net information server 40, wireless router 60, and communication network 15.

Communication network 15 is a communication channel, e.g. the Internet, to connect between program-related information server 30, net information server 40, and wireless router 60.

Broadcast station 20 is a facility to broadcast television programs. The broadcast station transmits, via a broadcast wave, a program-related information ID to identify the program-related information of the television program currently on the air, at an optional timing in parallel with the broadcast of the television program. Note that, in the embodiment, the program-related information ID is intended not only to identify the program-related information, but also to instruct terminal apparatus 70 to acquire the program-related information identified by the program-related information ID upon receiving the program-related information ID.

Program-related information server 30 is an apparatus which holds the program-related information on the television program to be possibly broadcast, and provides the program-related information via communication network 15, following an instruction from the outside. The program-related information includes, for example, at least one of advertisement information linked to contents of the television program currently-received with the television receiver and detailed information (an introduction of characters and the like) of the television program.

Net information server 40 is an apparatus which holds information (net information) and provides the information via communication network 15. The net information is, for example, advertisements and the like which are information typically not relevant to the television program; however, the net information may also be information relevant to the television program.

Wireless router 60 is a communications apparatus to relay communications between different communication networks. That is, the wireless router connects communication network 15 to both television receiver 50 and terminal apparatus 70 via wireless communication, and relays the wireless communication between television receiver 50 and terminal apparatus 70.

Television receiver 50 is an apparatus to receive the television program and the program-related information ID for identifying the program-related information of the television program being received, via the broadcast wave from broadcast station 20. In the embodiment, the television receiver displays the received television program, and also transfers the received program-related information ID to terminal apparatus 70 via wireless router 60.

Terminal apparatus 70 is an apparatus to receive, from television receiver 50, the program-related information ID which television receiver 50 has received. The terminal apparatus is a smartphone or the like, for example. In the embodiment, upon receiving the program-related information ID, terminal apparatus 70 acquires the program-related information corresponding to the program-related information ID from program-related information server 30, and displays the thus-acquired program-related information. In addition, the terminal apparatus acquires the net information from net information server 40 and displays the thus-acquired net information.

### [1-2. Configuration of Television Receiver]

FIG. 2 is a block diagram illustrating a configuration of television receiver 50 shown in FIG. 1. Television receiver 50 includes broadcast receiving unit 52, controller 54, display unit 56, and communication I/F 58.

Broadcast receiving unit 52 is a processing unit to receive the broadcast wave from broadcast station 20 and decode the wave.

Display unit 56 is a display output device having a display screen such as an LCD.

Communication I/F 58 is a communication processing unit to communicate with terminal apparatus 70 via wireless router 60 and also communicate with apparatuses connected to communication network 15. In the embodiment, the communication I/F is used to transfer, to terminal apparatus 70, the program-related information ID received with television receiver 50.

Controller 54 is a controller to control each of the constituent elements configuring television receiver 50, and includes a nonvolatile memory storing a program, a nonvolatile memory serving as a temporal storage area for executing the program, input-output ports, and a processor to execute the program. In the embodiment, controller 54 not only displays the television program received with broadcast receiving unit 52, but also executes a specific application program (APP). Upon receiving the program-related information ID with television receiver 50, the controller transfers the received program-related information ID to terminal apparatus 70.

### [1-3. Configuration of Terminal Apparatus]

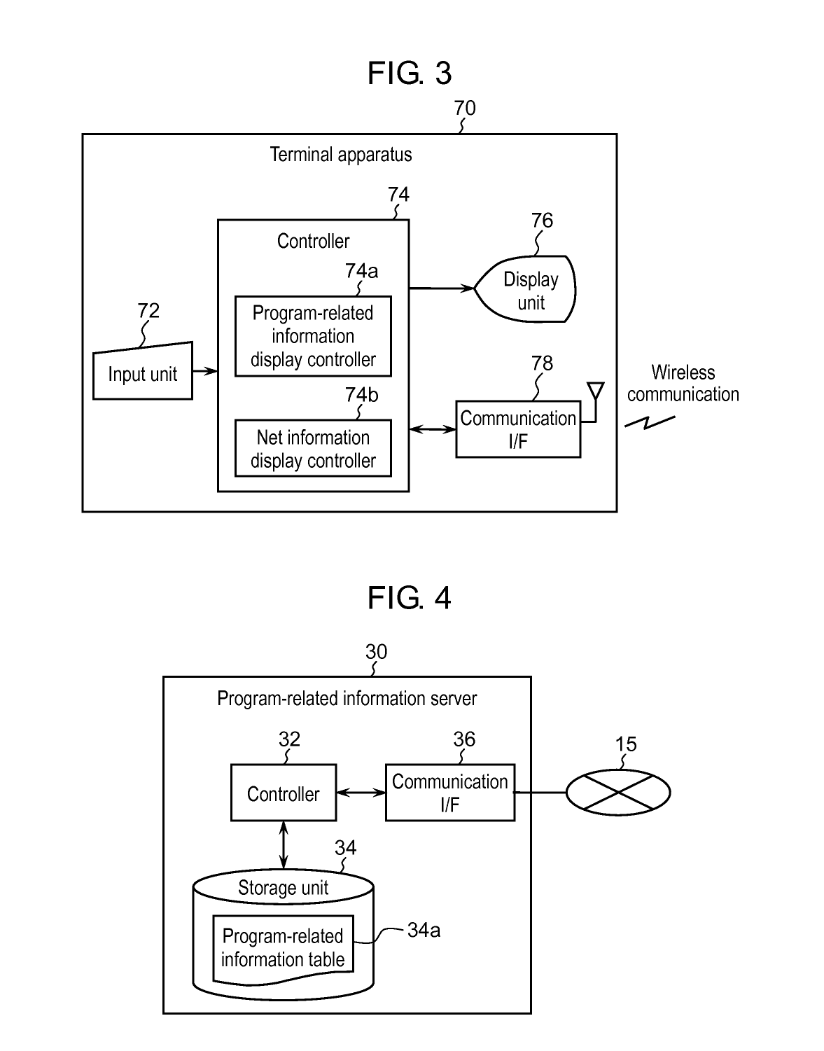

FIG. 3 is a block diagram illustrating a configuration of terminal apparatus 70 shown in FIG. 1. Terminal apparatus 70 includes input unit 72, controller 74, display unit 76, and communication I/F 78.

Input unit 72 is an input device, such as a button and a touch panel, which receives an instruction from a user.

Display unit 76 is a display output device having a display screen such as an LCD.

Communication I/F 78 is a communication processing unit to communicate with television receiver 50 via wireless router 60. In addition, the communication I/F communicate with program-related information server 30 and net information server 40 which both are connected to communication network 15. In the embodiment, communication I/F 78 is used to receive the program-related information ID transferred from television receiver 50. Using the received program-related information ID, the communication I/F is used to acquire the program-related information from program-related information server 30 and the net information from net information server 40.

Controller 74 is a controller to control each of the constituent elements configuring terminal apparatus 70, and includes a nonvolatile memory storing a program, a nonvolatile memory serving as a temporal storage area for executing the program, input-output ports, and a processor to execute the program. In the embodiment, controller 74 executes a specific APP and includes processing units, that is, program-related information display controller 74a and net information display controller 74b, which are used to execute the APP.

Program-related information display controller 74a is a processing unit which works in the following manner. That is, when terminal apparatus 70 receives the program-related information ID from television receiver 50, the program-related information display controller transmits the received program-related information ID to program-related information server 30, thereby acquiring the program-related information corresponding to the program-related information ID, from program-related information server 30. Then, the program-related information display controller displays the thus-acquired program-related information in a first display region on display unit 76. More specifically, every time of newly receiving the program-related information ID, program-related information display controller 74a acquires the program-related information corresponding to the program-related information ID, from program-related information server 30, and displays the thus-acquired program-related information in the first display region on display unit 76, thereby repeatedly updating the display in the first display region.

Net information display controller 74b is a processing unit which acquires, via communication network 15, the net information from net information server 40 connected to communication network 15, with the net information being held in net information server 40. Then, the net information display controller displays the thus-acquired net information in a second display region on display unit 76. At that time, net information display controller 74b displays the net information in the second display region after a lapse of a predetermined delay time since program-related information display controller 74a displays the program-related information in the first display region. More specifically, net information display controller 74b newly acquires the net information from net information server 40 and displays the thus-acquired net information in the second display region on display unit 76, thereby repeatedly updating the display in the second display region. At that time, net information display controller 74b updates the display in the second display region, after the lapse of the predetermined delay time since the display in the first display region is updated.

In the embodiment, program-related information display controller 74a acquires both the program-related information and delay information which indicates the predetermined delay time described above, from program-related information server 30. Then, net information display controller 74b displays the net information in the second display region, after the lapse of the predetermined delay time since the program-related information is displayed in the first display region, with the predetermined delay time being indicated by the delay information acquired by program-related information display controller 74a.

### [1-4. Configuration of Program-Related Information Server]

FIG. 4 is a block diagram illustrating a configuration of program-related information server 30 shown in FIG. 1. Program-related information server 30 is an apparatus which works in the following manner. That is, when receiving the program-related information ID from terminal apparatus 70, the program-related information server transmits, to terminal apparatus 70, the delay information indicating the predetermined delay time, as well as the program-related information corresponding to the received program-related information ID. Program-related information server 30 includes controller 32, storage unit 34, and communication I/F 36.

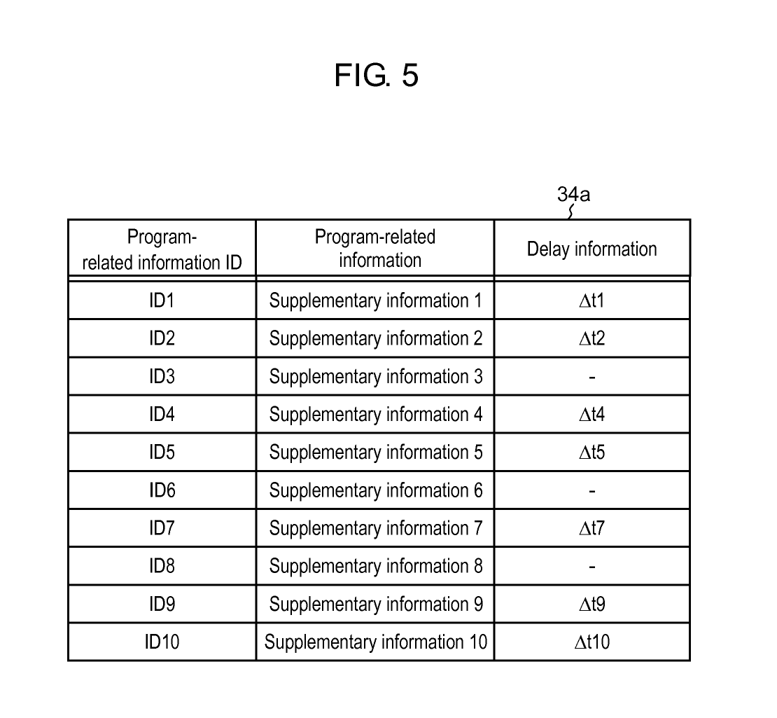

Storage unit 34 is a storage device which holds program-related information table 34a. Program-related information table 34a is a table, as shown in FIG. 5, that contains the program-related information ID, the program-related information corresponding to the program-related information ID, and the delay information corresponding to the program-related information ID, concerning a television program to be possibly broadcast. Note that, in FIG. 5, blanks in the column of delay information show the situations where no delay information is stored in program-related information table 34a because the delay information has yet to be determined.

Communication I/F 36 is a communication processing unit to communicate with apparatuses connected to communication network 15. In the embodiment, the communication I/F is used to communicate with terminal apparatus 70.

Controller 32 is a controller to control each of the constituent elements configuring program-related information server 30, and includes a nonvolatile memory storing a program, a nonvolatile memory serving as a temporal storage area for executing the program, input-output ports, and a processor to execute the program. In the embodiment, controller 32 performs the control in the following manner. That is, when receiving the program-related information ID from terminal apparatus 70 via communication I/F 36, controller 32 refers to program-related information table 34a to specify the program-related information and the delay information, with both corresponding to the received program-related information ID, and then transmits both the specified information to terminal apparatus 70 via communication I/F 36.

### [2. Operation]

### [2-1. Operation of Entire Information Provision System]

Next, a description will be made regarding an operation (that is, a method of providing information) of information provision system 10 configured as described above according to the embodiment.

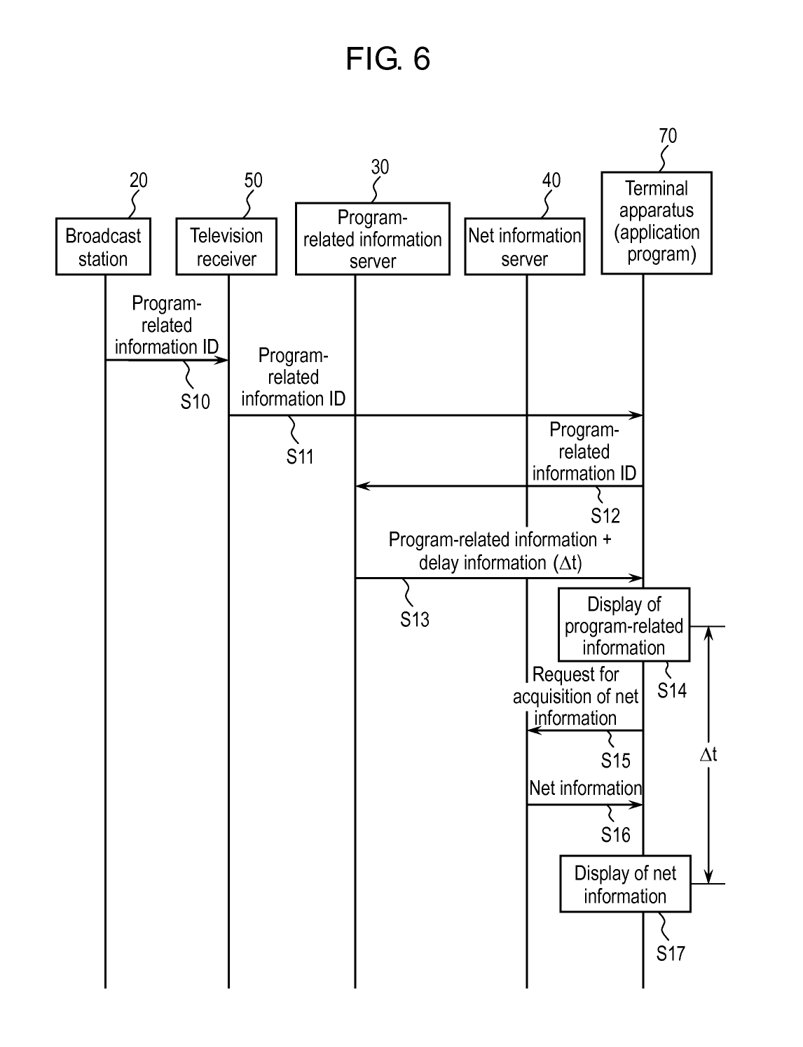

FIG. 6 is a communication sequence illustrating the operation of information provision system 10 according to the embodiment. The sequence shows communication procedures between broadcast station 20, television receiver 50, program-related information server 30, net information server 40, and terminal apparatus 70. Note that, in the figure, wireless router 60 is omitted.

First, broadcast station 20 transmits, via a broadcast wave, the program-related information ID to identify the program-related information of the television program currently on the air, at an optional timing in parallel with the broadcast of the television program (S10). With this step, television receiver 50 receives, via the broadcast wave, the television program and the program-related information ID to identify the program-related information, i.e. the information relevant to the television program currently received (a step of receiving the broadcast wave).

Television receiver 50, which has received the television program and the program-related information ID, displays the received television program on display unit 56, and also transfers the received program-related information ID to terminal apparatus 70 via wireless router 60 (S11). With this step, terminal apparatus 70 receives, from television receiver 50, the program-related information ID received by television receiver 50 (a step of receiving the program-related information ID).

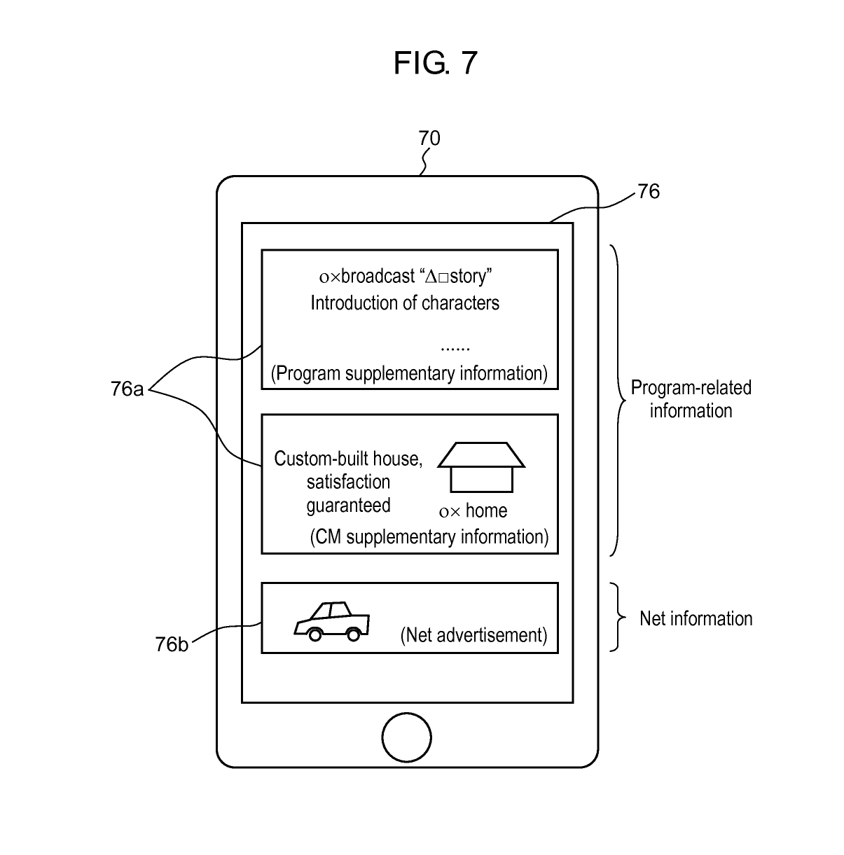

In terminal apparatus 70 that has received the program-related information ID, program-related information display controller 74a transmits the received program-related information ID to program-related information server 30 (S12), thereby acquiring both the program-related information and the delay information indicating the predetermined delay time (Δt) from program-related information server 30 (S13), with the both corresponding to the program-related information ID. Then, the program-related information display controller displays the thus-acquired program-related information in first display region 76a on display unit 76 as in the example of display shown in FIG. 7 (S14; program-related information displaying step). Note that, in the example shown in FIG. 7, the program-related information displayed in first display region 76a on display unit 76 of terminal apparatus 70 is detailed information (program supplementary information) of the television program currently received with television receiver 50 and an advertisement (CM(commercial message) supplementary information) relevant to the television program.

Then, in terminal apparatus 70, net information display controller 74b makes a request for acquisition of the net information from net information server 40 via communication network 15 (S15), thereby acquiring the net information from net information server 40 (S16). Then, the net information display controller displays the thus-acquired net information in second display region 76b on display unit 76 as in the example of display shown in FIG. 7 (S17; a step of displaying the net information). At that time, net information display controller 74b displays the net information in second display region 76b after a lapse of the predetermined delay time (Δt), which is indicated by the delay information acquired by program-related information display controller 74a, since the program-related information is displayed in first display region 76a. Note that, in the example shown in FIG. 7, the net information displayed in second display region 76b on display unit 76 of terminal apparatus 70 is a net advertisement.

The procedures described above (S10 to S17) are repeated every transmission of the program-related information ID from broadcast station 20 (that is, whenever terminal apparatus 70 newly receives the program-related information ID). That is, in the step of displaying the program-related information (S14), upon every new reception of the program-related information ID, the program-related information corresponding to the newly-received program-related information ID is acquired from program-related information server 30 and is displayed in the first display region, thereby allowing the repeated updates on the display in the first display region. In the step of displaying the net information (S17), the net information is newly acquired from net information server 40 and is displayed in the second display region, thereby allowing the repeated updates on the display in the second display region. Moreover, in the step of displaying the net information (S17), the display in the second display region is updated after the lapse of the predetermined delay time since the display in the first display region is updated. With these steps, in terminal apparatus 70, the display of the net information is changed after the lapse of the predetermined delay time since the display of the program-related information is changed. This allows the avoidance of inconvenience that the display of the net information is changed while a user is still viewing the program-related information displayed on terminal apparatus 70 (that is, before the user understands contents of the information), which prevents the occurrence of a problem that the user cannot concentrate on viewing the program-related information. As a result, this allows the user to reliably view, with greater concentration than before, the displays in the order of the television program, the program-related information, and the net information.

Note that, in Steps S14 to S17 of FIG. 6, the processes may be as follows. Until the lapse of the predetermined delay time delay time (Δt) since the display of the program-related information is updated, the display of the net information is not only not updated but also deleted (for example, the second display region is turned white or color identical to the background color of the application program (APP)) at the point in time when the predetermined delay time (Δt) is determined. Having performed the above steps, after the lapse of the predetermined delay time delay time (Δt), another display region for net information is prepared on display unit 76 of terminal apparatus 70 and the newly-acquired net information is displayed in the another display region. Such a process may be performed during a commercial message of the television broadcast, for example.

Even with such a process, it is possible to prevent the occurrence of the problem that the user cannot concentrate on viewing the program-related information because the new net information is not displayed until the lapse of the predetermined delay time (Δt) since the update of the display of the program-related information (that is, for the reason that the display of the net information has simply been deleted).

### [2-2. Method of Forming Delay Information]

It is noted that, as for the delay information in program-related information table 34a held in program-related information server 30, program-related information server 30 may acquire the delay information from the outside such as broadcast station 20 or, alternatively, program-related information server 30 may form the delay information on its own.

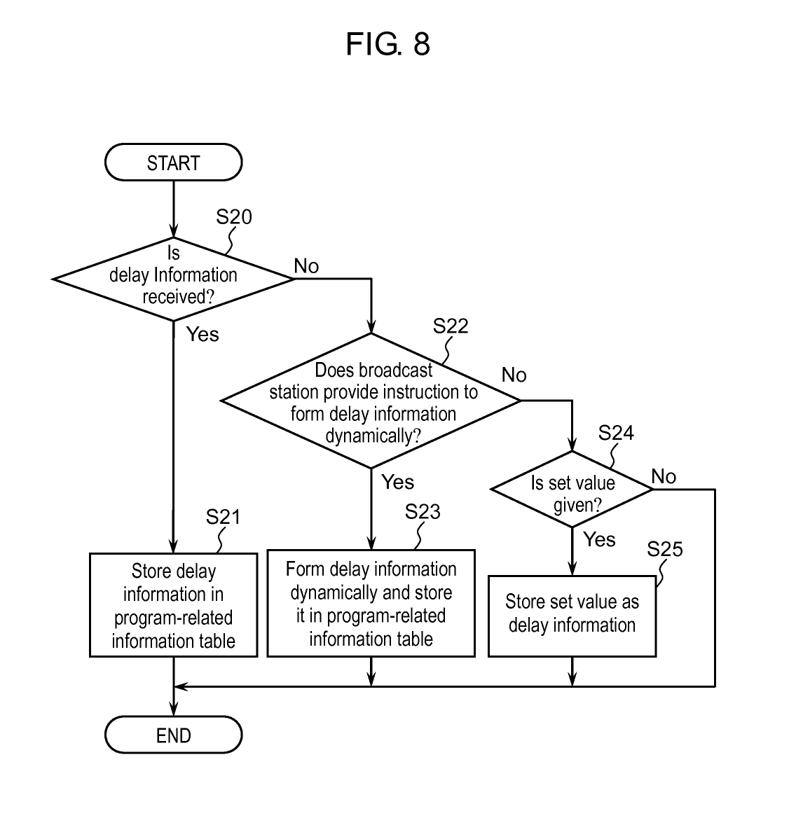

FIG. 8 is a flowchart illustrating a method of forming the delay information in program-related information table 34a that is held by program-related information server 30 according to the embodiment. Here, the figure shows the procedure of storing the delay information (the delay information corresponding to the program-related information ID) into program-related information table 34a, with the procedure being performed by program-related information server 30. Note that, as long as before actual transmission of the supplementary information performed by program-related information server 30, the procedure shown here can be performed at any time.

In program-related information server 30, when receiving the delay information from the outside such as broadcast station 20 via communication network 15 (Yes, in S20), controller 32 stores the delay information into a corresponding box in program-related information table 34a (S21).

On the other hand, when not receiving the delay information from the outside via communication network 15 (No, in S20), controller 32 determines whether or not it has received an instruction to dynamically form the delay information, from the outside such as broadcast station 20 (S22). When having received the instruction (Yes, in S22), the controller forms (that is, dynamically forms) the corresponding delay information based on the program-related information, and stores the thus-formed delay information into a corresponding box in program-related information table 34a (S23). Note that, in this dynamical formation, for example, controller 32 calculates the size of data of the program-related information to determine a predetermined delay time based on the calculated size of data, thereby forming the delay information which indicates the thus-predetermined delay time. More specifically, controller 32 holds a table which provides a correspondence between the predetermined delay time and a range of the size of data of the program-related information; the correspondence is determined such that, the larger the size of data of the program-related information is, the longer the predetermined delay time becomes. Then, controller 32 refers to the table to form the delay information based on the size of data of the program-related information.

On the other hand, when having received no instruction to dynamically form delay information (No, in S22), controller 32 determines whether or not there exists a predetermined set value (that is, whether or not a fixed value has been set) (S24). When there exists the predetermined set value (Yes, in S24), the controller stores the set value, as the delay information, into a corresponding box in program-related information table 34a (S25). Note that, when there exists no predetermined set value (No, in S24), the corresponding box in program-related information table 34a is in a state of absence (blank) of delay information.

With the aforementioned method of forming the delay information, the delay information in program-related information table 34a held by program-related information server 30 is acquired from the outside such as broadcast station 20 by program-related information server 30 or, alternatively, is formed by program-related information server 30.

### [2-3. Method of Transmitting Delay Information]

Note that, in the case where program-related information server 30 stores no delay information corresponding to the program-related information ID in program-related information table 34a when the delay information is requested by terminal apparatus 70, program-related information server 30 may dynamically forms the requested delay information after having received the request from terminal apparatus 70.

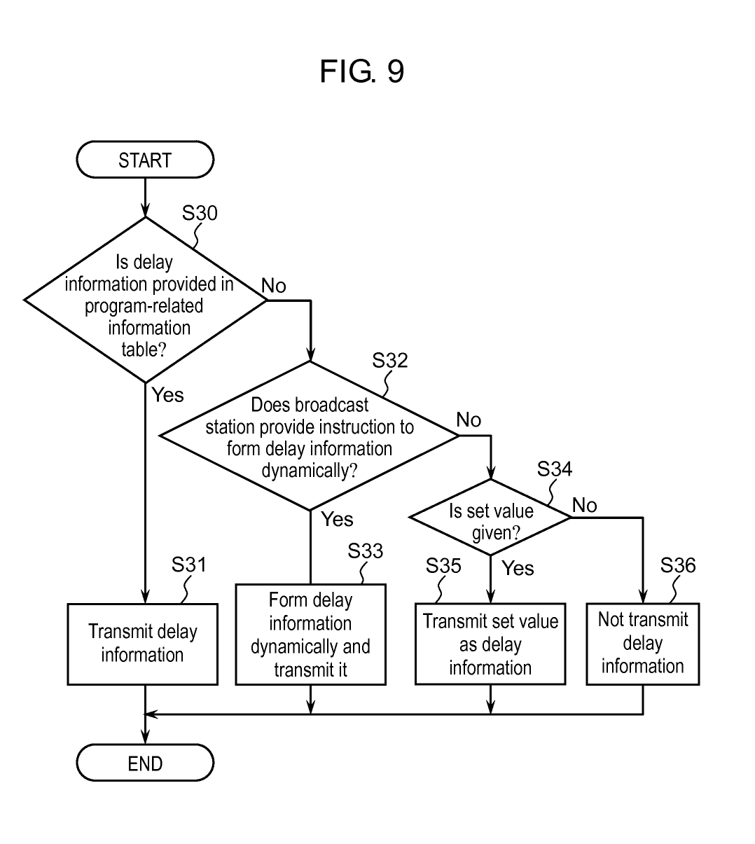

FIG. 9 is a flowchart of a procedure by which program-related information server 30 transmits the delay information to terminal apparatus 70, according to the embodiment. Here, the flowchart shows the procedure of transmitting the delay information corresponding to the program-related information ID, with the delay information being requested from terminal apparatus 70. In addition, the flowchart includes a procedure for the case where the delay information corresponding to the program-related information ID, which is requested from terminal apparatus 70, is not stored in program-related information table 34a.

First, in program-related information server 30, controller 32 determines whether or not the delay information corresponding to the program-related information ID, which is requested from terminal apparatus 70, is stored in program-related information table 34a (S30). When the delay information is stored (Yes, in S30), the controller reads the delay information from program-related information table 34a and transmits the thus-read information to terminal apparatus 70 (S31).

On the other hand, when the delay information corresponding to the program-related information ID, which is requested from terminal apparatus 70, is not stored in program-related information table 34a (No, in S30), controller 32 determines whether or not the controller has received an instruction to dynamically form the delay information, from the outside such as broadcast station 20 (S32). When the controller has received the instruction (Yes, in S32), the controller forms (that is, dynamically forms) the corresponding delay information based on the program-related information, and transmits the thus-formed delay information to terminal apparatus 70 (S33). Note that, in this dynamical formation, for example, controller 32 calculates the size of data of the program-related information to determine a predetermined delay time based on the calculated size of the data, thereby forming the delay information which indicates the thus-predetermined delay time. More specifically, controller 32 holds a table which provides a correspondence between the predetermined delay time and a range of the size of data of the program-related information; the correspondence is determined such that, the larger the size of data of the program-related information is, the longer the predetermined delay time becomes. Then, controller 32 refers to the table to form the delay information based on the size of data of the program-related information.

On the other hand, when having received no instruction to dynamically form delay information (No, in S32), controller 32 determines whether or not there exists a predetermined set value (that is, whether or not a fixed value has been set) (S34). When there exists the predetermined set value (Yes, in S34), the controller transmits the set value, as the delay information, to terminal apparatus 70 (S35). Note that, when there exists no predetermined set value (No, in S34), controller 32 transmits only the corresponding program-related information to terminal apparatus 70, and transmits no delay information to terminal apparatus 70 (S36).

With the method of transmitting the delay information as described above, when the delay information corresponding to the program-related information ID, which is requested from terminal apparatus 70, is not stored in program-related information table 34a, the corresponding delay information is dynamically formed by program-related information server 30 and is transmitted to terminal apparatus 70.

### Modified Exemplary Embodiments

It is noted, however, that terminal apparatus 70 may determine the predetermined delay information on its own (that is, dynamically form the delay information) when not receiving the delay information from program-related information server 30.

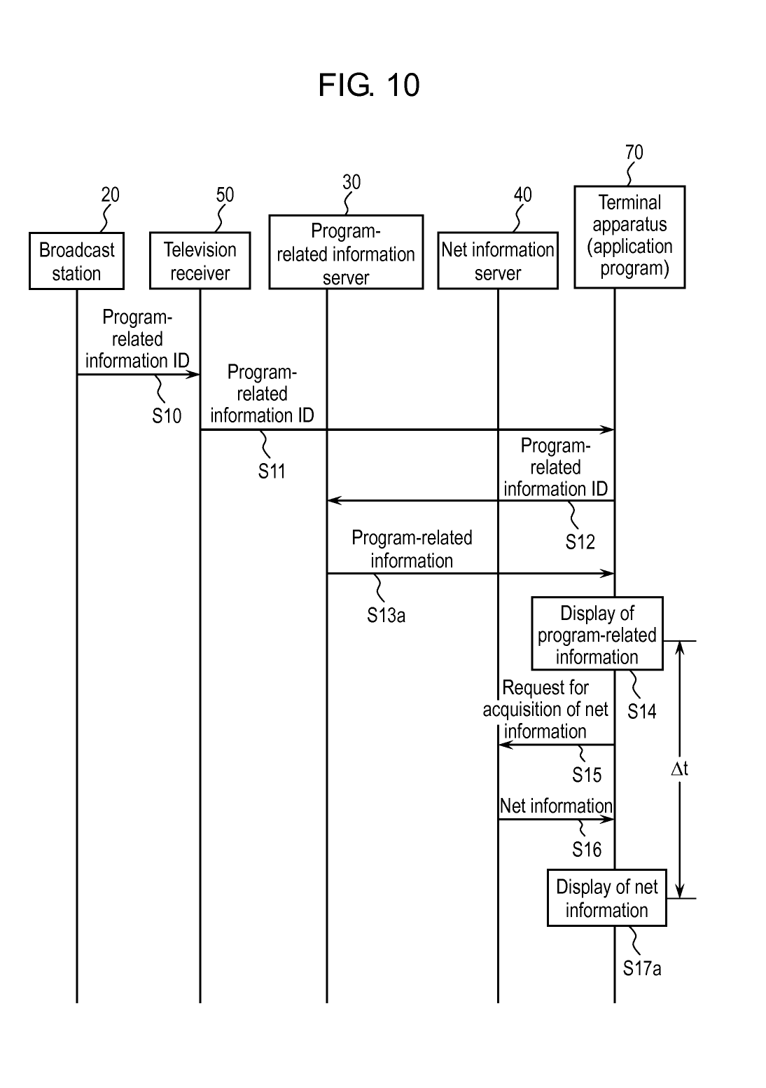

FIG. 10 is a communication sequence illustrating an operation of information provision system 10 according to a modified example of the embodiment. Here, the operation of information provision system 10 is shown for the case where terminal apparatus 70 does not receive the delay information from program-related information server 30. Note that the communication sequence of the figure is identical to the communication sequence of FIG. 6 except only for Step S13 and Step S17. Hereinafter, the same steps as those of FIG. 6 are designated by the same reference numerals and symbols, and descriptions thereof are omitted. The description will focus only on the points of the exception.

In terminal apparatus 70 that have received the program-related information ID, program-related information display controller 74a transmits the received program-related information ID to program-related information server 30 (S12). After that, the program-related information display controller acquires only the program-related information (i.e. the information not containing the delay information) corresponding to the program-related information ID from program-related information server 30 (S13a).

Moreover, in terminal apparatus 70, net information display controller 74b acquires the net information from net information server 40 (S16) and displays the acquired net information in the second display region on display unit 76 (517a). In displaying the net information, the net information display controller displays the net information in the second display region after a lapse of the predetermined delay time (Δt), which the controller has set on its own, since the program-related information is displayed in the first display region. It is noted, however, that the predetermined delay time may be determined to be a set value (fixed value) which has been determined in advance or, alternatively, the predetermined delay time may be determined (dynamically determined) based on the program-related information which program-related information display controller 74a has acquired. Moreover, in the dynamical determination, for example, second display region 76b may calculate the size of data of the program-related information, which program-related information display controller 74a has acquired, to determine the predetermined delay time based on the calculated size of the data. More specifically, second display region 76b may hold a table which provides a correspondence between the predetermined delay time and a range of the size of data of the program-related information; the correspondence is determined such that, the larger the size of data of the program-related information is, the longer the predetermined delay time becomes. Then, second display region 76b may refer to the table to form the predetermined delay information based on the size of data of the program-related information.

With the modified embodiment described above, when terminal apparatus 70 does not receive the delay information from program-related information server 30, the predetermined delay time is determined by terminal apparatus 70 (that is, the delay information is dynamically determined).

(Summary)

As described above, the method of providing information according to the embodiments is as follows. Information provision system 10 is a system to provide the program-related information, which is supplementary information linked to contents of a television program, in parallel with broadcast of the television program. The information provision system includes program-related information server 30, television receiver 50, and terminal apparatus 70. The program-related information server holds the program-related information of the television program to be possibly broadcast, and provides the program-related information via communication network 15, following an instruction from the outside. The television receiver receives, via a broadcast wave, both the television program and the program-related information ID to identify the program-related information of the thus-received television program. The terminal apparatus receives, from television receiver 50, the program-related information ID which television receiver 50 has received. Terminal apparatus 70 includes display unit 76, program-related information display controller 74a, and net information display controller 74b. The display unit includes a display screen. When receiving the program-related information ID, the program-related information display controller transmits the received program-related information ID to program-related information server 30, thereby acquiring the program-related information corresponding to the program-related information ID from program-related information server 30. Then, the program-related information display controller displays the thus-acquired program-related information in first display region 76a on display unit 76. The net information display controller acquires, via communication network 15, the net information from the net information server connected to communication network 15, with the net information being held in the net information server. Then, the net information display controller displays the thus-acquired net information in second display region 76b on display unit 76. Net information display controller 74b displays the net information in second display region 76b after a lapse of the predetermined delay time since the program-related information is displayed in first display region 76a.

At that time, every time of newly receiving the program-related information ID, program-related information display controller 74a acquires the program-related information corresponding to the program-related information ID from program-related information server 30, and displays the thus-acquired program-related information in first display region 76a, thereby repeatedly updating the display in first display region 76a. Net information display controller 74b newly acquires the net information from the net information server and displays the thus-acquired net information in second display region 76b, thereby repeatedly updating the display in second display region 76b. Net information display controller 74b updates the display in second display region 76b, after the lapse of the predetermined delay time since the display in first display region 76a is updated. With this configuration, in terminal apparatus 70, the display of the net information is changed after the display of the program-related information has been changed. This leads to the avoidance of a problem that the display of the net information is changed before a user understands contents of the program-related information displayed on terminal apparatus 70. As a result, this allows the user to reliably view, with greater concentration than before, the displays in the order of the television program, the program-related information, and the net information.

Moreover, when receiving the program-related information ID from terminal apparatus 70, program-related information server 30 transmits, to terminal apparatus 70, the delay information indicating the predetermined delay time, as well as the program-related information corresponding to the received program-related information ID. Program-related information display controller 74a acquires the program-related information and the delay information from program-related information server 30.

Net information display controller 74b displays the net information in second display region 76b, after the lapse of the predetermined delay time since the program-related information is displayed in first display region 76a, with the predetermined delay time being indicated by the delay information acquired by program-related information display controller 74a.

With this configuration, the predetermined delay time is determined from the delay information that is transmitted from program-related information server 30.

Moreover, program-related information server 30 holds program-related information table 34a that contains the program-related information ID, the program-related information corresponding to the program-related information ID, and the delay information corresponding to the program-related information ID, concerning the television program to be possibly broadcast. When receiving the program-related information ID from terminal apparatus 70, the program-related information server refers to program-related information table 34a, and identifies both the program-related information corresponding to the received program-related information ID and the delay information, followed by transmitting the both to terminal apparatus 70.

With this operation, the delay information registered in program-related information table 34a held by program-related information server 30 is transmitted from program-related information server 30 to terminal apparatus 70.

Furthermore, program-related information server 30 holds program-related information table 34a that contains the program-related information ID and the program-related information corresponding to the program-related information ID, concerning the television program to be possibly broadcast. When receiving the program-related information ID from terminal apparatus 70, the program-related information server refers to program-related information table 34a to identify the program-related information corresponding to the received program-related information ID, and forms the delay information based on the identified program-related information, followed by transmitting both the identified program-related information and the formed delay information to terminal apparatus 70.

For example, program-related information server 30 determines the predetermined delay time based on a size of data of the program-related information, and then forms the delay information that indicates the thus-predetermined delay time.

With this operation, the delay information is dynamically formed by program-related information server 30 and then transmitted to terminal apparatus 70.

Moreover, net information display controller 74b determines the predetermined delay time based on the program-related information which is acquired by the program-related information display controller, and displays the net information in second display region 76b after the lapse of the thus-predetermined delay time since the program-related information is displayed in first display region 76a.

For example, net information display controller 74b determines the predetermined delay time based on the size of data of the program-related information.

With this operation, the predetermined delay time is dynamically determined by terminal apparatus 70.

Moreover, the method of providing information according to the embodiments is intended to provide the program-related information, which is supplementary information linked to contents of the television program, in parallel with the broadcast of the television program. The method includes the steps of: receiving the broadcast wave, receiving the program-related information, displaying the program-related information, and displaying the net-information. In the step of receiving the broadcast wave, television receiver 50 receives both the television program and the program-related information ID to identify the program-related information, i.e. the information relevant to the television program currently received. In the step of receiving the program-related information, terminal apparatus 70 receives, from television receiver 50, the program-related information ID that television receiver 50 has received. In the step of displaying the program-related information, when receiving the program-related information ID, terminal apparatus 70 transmits the received program-related information ID to program-related information server 30 via communication network 15, thereby acquiring the program-related information corresponding to the program-related information ID from program-related information server 30. Then, the terminal apparatus displays the thus-acquired program-related information in first display region 76a on display unit 76 disposed in terminal apparatus 70. In the step of displaying the net-information, terminal apparatus 70 acquires the net information, which is the information held by the net information server, from the net information server connected to communication network 15, via communication network 15. Then, the terminal apparatus displays the net information in second display region 76b on display unit 76. Moreover, in the step of displaying the net-information, the net information is displayed in second display region 76b after the lapse of the predetermined delay time since the program-related information is displayed in first display region 76a.

At that time, in the step of displaying the program-related information, every time of newly receiving the program-related information ID, the program-related information corresponding to the received program-related information ID is acquired from program-related information server 30 and is displayed in first display region 76a, thereby repeatedly updating the display in first display region 76a. In the step of displaying the net-information, the net information is newly acquired from the net information server and is displayed in second display region 76b, thereby repeatedly updating the display in second display region 76b. Moreover, in the step of displaying the net-information, the display in second display region 76b is updated after the lapse of the predetermined delay time since the display in first display region 76a is updated.

With this configuration, in terminal apparatus 70, the display of the net information is changed after the display of the program-related information has been changed. This leads to the avoidance of a problem where the display of the net information is changed before the user understands contents of the program-related information displayed on terminal apparatus 70. As a result, this allows the user to reliably view, with greater concentration than before, the displays in the order of the television program, the program-related information, and the net information.

### Other Exemplary Embodiments

As described above, the information provision system and the method of providing information according to the present disclosure have been described based on the exemplary embodiments and the modified exemplary embodiments; however, the present invention is not limited to these exemplary embodiments and modified ones. As long as not departing from the gist of the present invention, any embodiments obtained by applying various modifications, which will occur to those skilled in the art, to the exemplary embodiments and modified ones and obtained by optionally combining the constituent elements of different ones of the exemplary embodiments and modified ones, fall within the scope of the present invention.

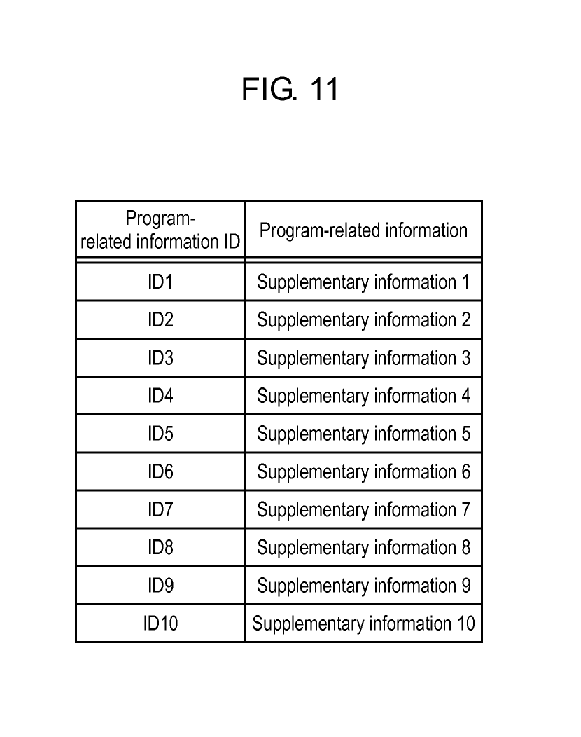

For example, in the embodiments described above, program-related information server 30 includes program-related information table 34a that contains the delay information, as shown in FIG. 5; however, the program-related information server may include a program-related information table not containing the delay information, as shown in FIG. 11. Even with such a configuration, program-related information server 30 can dynamically form the delay information and transmit it to terminal apparatus 70, and can transmit the delay information indicating the predetermined set value to terminal apparatus 70, in accordance with Steps S32 to S35 shown in FIG. 9. Moreover, in terminal apparatus 70, when the delay information cannot be acquired from program-related information server 30, net information display controller 74b displays the net information in the second display region after a lapse of the predetermined delay time (Δt), which net information display controller has determined on its own, since the program-related information is displayed in the first display region, as indicated by Step S17a shown in FIG. 10. Note that, the method of determining the predetermined delay time may be such that the delay time is determined to be a predetermined set value (fixed value) or is determined (dynamically determined) based on the program-related information acquired by program-related information display controller 74a.

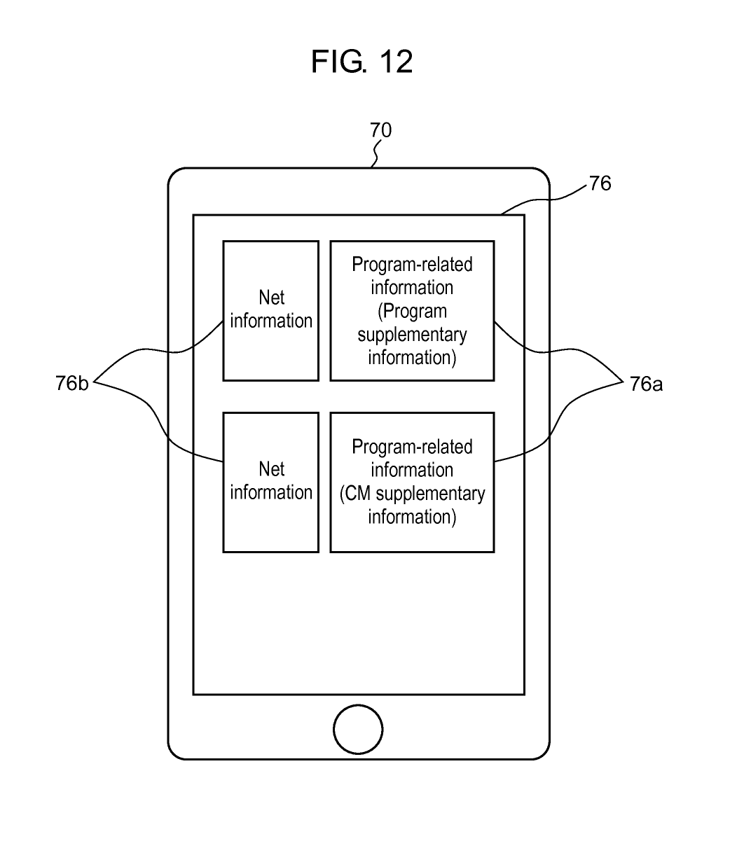

Moreover, in the embodiments described above, on display unit 76 of terminal apparatus 70, both the program-related information and the net information are displayed as in the example of screen display shown in FIG. 7; however, the layout of display of both the program-related information and the net information is not limited to the example shown in FIG. 7. For example, as shown in FIG. 12, the display screen on display unit 76 of terminal apparatus 70 is split into two side-by-side regions (i.e. first display region 76a and second display region 76b). The program-related information may be displayed in one (first display region 76a) of the regions, whereas the net information may be displayed in the other (second display region 76b).

Moreover, the present invention may be implemented not only in both the information provision system described above and the method of providing information described above, but also in other ones including: One is a program in which, of the steps included in the method of providing information described above, the steps to be executed by television receiver 50 are executed by a processor included in television receiver 50; another one is a program in which, of the steps in the method described above, the steps to be executed by terminal apparatus 70 are executed by a processor included in terminal apparatus 70; another one is a program in which, of the steps in the method described above, the steps to be executed by program-related information server 30 are executed by a processor included in program-related information server 30; and another one is a computer readable record medium in which these programs described above are recorded.

As described above, the exemplary embodiments and modified ones have been described to exemplify the technology according to the present disclosure. To that end, the accompanying drawings and the detailed descriptions have been provided. Therefore, the constituent elements described in the accompanying drawings and the detailed descriptions may include not only essential elements for solving the problems, but also inessential ones for solving the problems which are described only for the exemplification of the technology described above. For this reason, it should not be acknowledged that these inessential elements are considered to be essential only on the grounds that these inessential elements are described in the accompanying drawings and/or the detailed descriptions.

Moreover, because the aforementioned embodiments are used only for the exemplification of the technology disclosed herein, it is to be understood that various changes and modifications, replacements, additions, omissions, and the like may be made to the embodiments without departing from the scope of the appended claims or the scope of their equivalents.

The technology according to the present disclosure is applicable to information provision systems to provide program-related information in parallel with the broadcast of a television program. Specifically, the technology according to the present disclosure is applicable to an information provision system and the like in which net information together with the program-related information is displayed on a terminal apparatus such as a smartphone.

What is claimed is:

1. An information provision system for providing program-related information in parallel with broadcast of a television program, the program-related information being supplementary information linked to contents of the television program, the information provision system comprising:
a program-related information server for holding the program-related information of the television program to be possibly broadcast, and for providing the program-related information via a communication network, following an instruction from an outside;
a television receiver for receiving, via a broadcast wave, the television program and a program-related information ID to identify the program-related information of the television program; and
a terminal apparatus for receiving, from the television receiver, the program-related information ID received by the television receiver, the terminal apparatus including:
a display unit including a display screen;
a program-related information display controller for transmitting the received program-related information ID to the program-related information server upon receiving the program-related information ID, for acquiring the program-related information corresponding to the received program-related information ID from the program-related information server, and for displaying the acquired program-related information in a first display region on the display unit; and
a net information display controller for acquiring net information from a net information server via the communication network, and for displaying the acquired net information in a second display region on the display unit, the net information being held by the net information server connected to the communication network,
wherein the net information display controller displays the acquired net information in the second display region after a lapse of a predetermined delay time since the program-related information is displayed in the first display region.

2. The information provision system according to claim 1,
wherein, upon every new reception of program-related information ID, the program-related information display controller acquires the program-related information corresponding to the received program-related information ID from the program-related information server, and displays the acquired program-related information in the first display region to repeatedly update a display in the first display region;
the net information display controller newly acquires the net information from the net information server, and displays the acquired net information in the second display region to repeatedly update a display in the second display region; and
the net information display controller updates the display in the second display region after the lapse of the predetermined delay time since the display in the first display region is updated.

3. The information provision system according to claim 1,
wherein when receiving the program-related information ID from the terminal apparatus, the program-related information server transmits, to the terminal apparatus, not only the program-related information corresponding to the received program-related information ID but also delay information indicating the predetermined delay time;
the program-related information display controller acquires the program-related information and the delay information, from the program-related information server; and
the net information display controller displays the net information in the second display region after the lapse of the predetermined delay time indicated by the delay information acquired by the program-related information display controller since the program-related information is displayed in the first display region.

4. The information provision system according to claim 3,
wherein, concerning the television program to be possibly broadcast, the program-related information server holds a program-related information table containing
the program-related information ID,
the program-related information corresponding to the program-related information ID, and
the delay information corresponding to the program-related information ID; and,
when receiving the program-related information ID from the terminal apparatus, the program-related information server refers to the program-related information table to specify both the program-related information and the delay information, the both corresponding to the received program-related information ID, and transmits the specified both to the terminal apparatus.

5. The information provision system according to claim 3,
wherein, concerning the television program to be possibly broadcast, the program-related information server holds a program-related information table containing
the program-related information ID, and
the program-related information corresponding to the program-related information ID; and,
when receiving the program-related information ID from the terminal apparatus, the program-related information server refers to the program-related information table to specify the program-related information corresponding to the received program-related information ID, forms the delay information based on the specified program-related information, and transmits the specified program-related information and the formed delay information to the terminal apparatus.

6. The information provision system according to claim 5, wherein the program-related information server determines the predetermined delay time based on a size of data of the program-related information, and forms the delay information indicating the thus-determined predetermined delay time.

7. The information provision system according to claim 1, wherein the net information display controller determines the predetermined delay time based on the program-related information acquired by the program-related information display controller, and displays the net information in the second display region after the lapse of the thus-determined predetermined delay time since the program-related information is displayed in the first display region.

8. The information provision system according to claim 7, wherein the net information display controller determines the predetermined delay time based on a size of data of the program-related information.

9. The information provision system according to claim 1, wherein the communication network is the Internet.

10. The information provision system according to claim 1, wherein the program-related information contains at least one of advertisement information relevant to the television program and detailed information of the television program.

11. A method of providing program-related information in parallel with broadcast of a television program, the program-related information being supplementary information linked to contents of the television program, the method comprising the steps of:
receiving a broadcast wave, wherein a television receiver receives, via the broadcast wave, the television program and a program-related information ID to identify the program-related information relevant to the television program;
receiving the program-related information ID, wherein a terminal apparatus receives, from the television receiver, the program-related information ID received by the television receiver;
displaying the program-related information,
wherein upon receiving the program-related information ID, the terminal apparatus transmits the received program-related information ID to a program-related information server via a communication network,
the terminal apparatus acquires the program-related information corresponding to the received program-related information ID from the program-related information server, and
the terminal apparatus displays the acquired program-related information in a first display region on a display unit included in the terminal apparatus; and
displaying net information,
wherein the terminal apparatus acquires the net information from a net information server via the communication network, the net information being held by the net information server connected to the communication network, and
the terminal apparatus displays the acquired net information in a second display region on the display unit,
wherein in the step of displaying the net information, the net information is displayed in the second display region after a lapse of a predetermined delay time since the program-related information is displayed in the first display region.

12. The method of providing program-related information according to claim 11,
wherein, in the step of displaying the program-related information, upon every new reception of the program-related information ID, the program-related information corresponding to the newly-received program-related information ID is acquired from the program-related information server, and displayed in the first display region to repeatedly update a display in the first display region;
in the step of displaying the net information, the net information is newly acquired from the net information server, and displayed in the second display region to repeatedly update a display in the second display region; and
in the step of displaying the net information, the display in the second display region is updated after the lapse of the predetermined delay time since the display in the first display region is updated.
